(19) United States
(12) Patent Application Publication
(10) Pub. No.: US 2009/0199203 A1
(43) Pub. Date: Aug. 6, 2009

(54) INTERACTING WITH APPLICATIONS VIA AN INSTANT MESSAGING CLIENT TO PERFORM APPLICATION SPECIFIC TASKS

(75) Inventors: RICHARD KNASTER, VOORHEES, NJ (US); LUCINIO SANTOS-GOMEZ, DURHAM, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/024,205

(22) Filed: Feb. 1, 2008

(51) Int. Cl. G06F 9/44; G06F 15/16

(52) U.S. Cl. 719/313; 709/206

(57) ABSTRACT

The present invention discloses a solution for interacting with applications via an instant messaging client to perform application specific tasks. An instant messaging client refers to any client able to communicate in real-time or near real-time using messages, such as an Instant Messaging (IM) client, a chat client, a text messaging client, and the like. In the solution, a user can establish a “chat session” with an application to perform a variety of tasks without directly interacting with the graphical user interface (GUI) of the application. The user can communicate with the application using messages, which are conveyed from a client across an application program interface (API) to a targeted application, which triggers an application response, which is conveyed back across the API, which is ultimately presented to a user through the client.

### BACKGROUND

1. Field of the Invention

The present invention relates to the field of instant messaging software applications and, more particularly, to interacting with applications via an instant messaging client to perform application specific tasks.

2. Description of the Related Art

Computer users are often required to interact with many different applications. For example, a user of an email program can receive attachments, each of which require a related application to be opened before the attachment can be viewed. Individually executing each of these applications may not tax computing resources, but when running several of the applications concurrently, a computing device can be placed under sever load and become unresponsive as a result. When the computing device is slowed, a user's ability to efficiently interact with the programs can be hampered, which has a negative impact on productivity. To work around this problem, users often exit applications when they have finished performing the task required by the application. This, however, often times exacerbates the problem with delays as the user spends a majority of time waiting for applications to start up and exit, essentially reducing user productivity.

Another problem facing users utilizing multiple applications relates to challenges using multiple differently configured interfaces. While two applications can be functionally similar, they can require a very different series of steps to perform the same task. This is a common hurdle with graphical user interfaces, which users often experience. Users are forced to learn several different methods to accomplish the same tasks in different applications. Further, the same application can vary significantly between revisions forcing users to re-learn how to perform even simple tasks. Additionally, it is not uncommon that frequently used program functionality can be difficult to navigate to in a given application. In worse cases, applications that are poorly designed can severely inhibit a user's ability to perform even the simplest of tasks.

All of these issues translate to lost productivity and frustration on the part of the user. Adding to this frustration is a fact that users often are only accessing a particular application to receive a relatively simple response, which requires a minuscule portion of the overall capabilities of the application. Nevertheless, the full capabilities of the application are opened, which needlessly consumes computing resources and which can add confusion by presenting extraneous options not needed for providing the user desired response. What is needed is a natural, uniform, and easy-to-use mechanism for performing relatively simple application operations without fully opening the each application.

### SUMMARY OF THE INVENTION

The present invention discloses a solution for interacting with applications via an instant messaging (IM) client to perform application specific tasks. Instant Messaging as used generically herein to refer to any kind of messaging exchange in real-time or near real-time including, but not limited to, a text, voice, video, data, graphics, mobile instant messaging, etc. In the solution, a user can establish an IM session with an application to perform a variety of tasks without directly interacting with the graphical user interface (GUI) of the application. The user can communicate with the application using IM messages, which are conveyed from a client across an application program interface (API) to a targeted application, which triggers an application response, which is conveyed back across the API, which is ultimately presented to a user through the IM client. Applications available for interaction can appear as “users” in the same contact list employed by the IM client. Simple and complex interactions can be achieved based on the functionality exposed to the IM client. Further, interactions can occur between an IM application and a set of local applications on a computing device, or across a network between an IM application and one or more remotely located applications.

The present invention can be implemented in accordance with numerous aspects consistent with the materials presented herein. One aspect of the present invention can include a method for interacting with applications from within an IM interface. The method can establish an application entity as a communicator of an IM session. The application entity can be an application or a published application function, which are implemented external to software of an IM client and external to software of an IM server. Interactions can be permitted between a user and the application entity during the IM session. The application entity can perform programmatic actions based upon semantic information exchanged during the permitted interactions.

Another aspect of the present invention can include an IM software program that includes a set of programmatic instructions digitally encoded in a machine readable medium configured to be executed by at least one computing device. The set of programmatic instructions can be configured to permit at least one software application to participate in an IM communication as if the software application were a human participant of a real-time IM session.

Still another aspect of the present invention can include an IM graphical user interface that includes a session input region and a session output region. The session input region can receive user entered text or other input, which is submitted to other users participating in a real-time IM communication session. The session input region can also receive text or other input which is conveyed to at least one application through an associated application program interface. The receiving applications can perform programmatic actions based upon semantic content contained within the received text. The session output region can present text or other output conveyed among users during the real-time IM communication session. The session output region can also present text or other output generated by the at least one application that has been conveyed through the application program interface. The application can be treated by the IM graphical user interface as if the at least one application was a human participant of the real-time IM session.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for allowing a user to interact with an application via an instant messaging (IM) graphical user interface (GUI) in accordance with an embodiment of the inventive arrangements disclosed herein.

FIG. 2 shows a sample graphical user interface (GUI) for interacting with applications via IM messages in accordance with an embodiment of the inventive arrangements disclosed herein.

FIG. 3 shows a sample graphical user interface of an IM contact list of an IM application able to interact with applications in accordance with an embodiment of the inventive arrangements disclosed herein.

FIG. 4 is a schematic diagram illustrating a method for interacting with applications via an IM client to perform application specific tasks in accordance with an embodiment of the inventive arrangements disclosed herein.

### DETAILED DESCRIPTION OF THE INVENTION

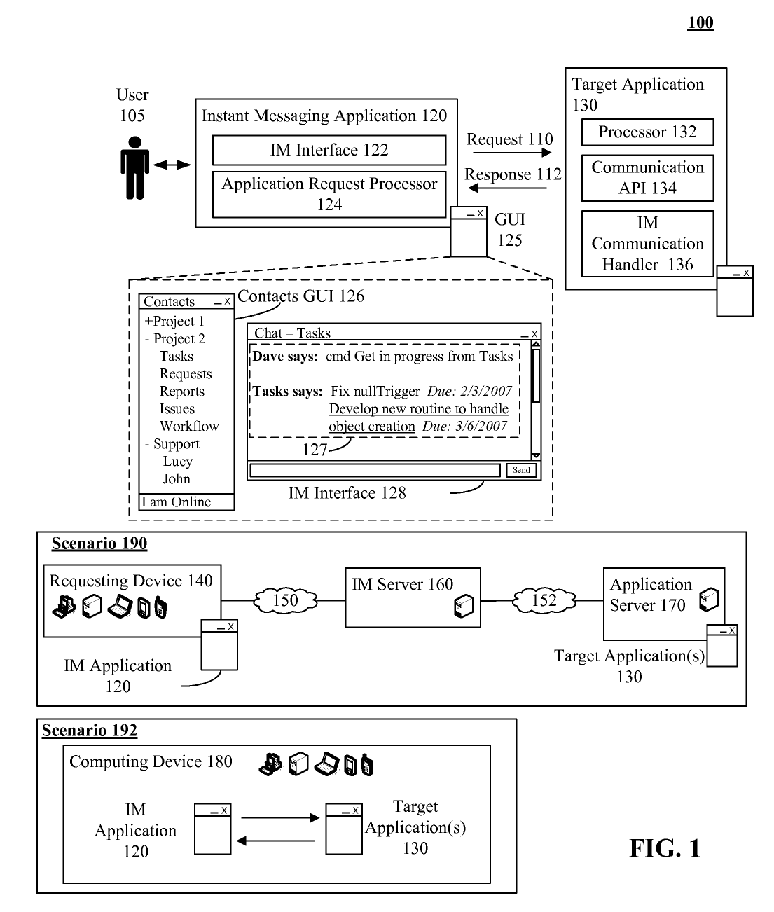

FIG. 1 is a schematic diagram illustrating a system 100 for allowing a user to interact with an application via an instant messaging (IM) graphical user interface (GUI) 125 in accordance with an embodiment of the inventive arrangements disclosed herein. Instant messaging as used herein refers to any real-time/near real-time communication involving an exchange of text or other message. Instant messaging can include, but is not limited to, Instant Messaging (IM), chatting, text messaging, video teleconferencing with messaging, co-browsing, and the like. Types of content able to be conveyed during an IM session can include, but are not limited to, text, voice, video, data, graphics, mobile instant messaging, etc.

In system 100, a user 105 can interact with a target application 130 via IM GUI 125 to perform tasks in target application 130. That is, a request 110 from IM application 120 can be processed by target application 130, which produces a response 112. The request 110 is sent and response 112 presented from an IM interface 128. Multiple applications 130 can interact with the IM application 120, which permits a uniform, lightweight, and intuitive technique for user 105 to receive application responses 112 for simple requests 110 without needing to execute a full featured interface for each target application 130. Use of the IM application 120 to interact with the target application(s) 130 can save considerable computing resources, can minimize interface related user confusions, and can improve overall response times.

A sample interaction involving the IM application 120 and the target application 130 occurring through a graphical user interface 125 is illustrated. As shown, a contact (e.g., a buddy list) window 126 can show entities available for IM interactions. These entities can include a set of people (e.g., Lucy and John) as well as one or more application functions or objects (e.g., tasks, requests, reports, issues, workflow). In contact window 126, the interaction entities can be grouped and/or hieratically organized by category. In one embodiment different categories can exist for different projects that a user 105 is involved with. Different applications 130 can also include groupings, where interactive entities can include callable application functions. Grouping application/application functions in a collapsible hierarchy within contact window 126 permits a user 105 to hide target applications 130 at will, which minimizes potential problems with the window 126 being “cluttered” with application related communication items. Within IM interface 128 a user 105 (e.g., Dave) can initiate a new request 110 (e.g., “Get in progress from tasks”) and can be presented with application responses 112 (e.g., “Fix nullTrigger Due: Feb. 3, 2007 . . . ”).

It should be appreciated, that target application 130 can generate a response 112 based upon detected events instead of in response to a specific request 110. For example, the IM application 120 can function as an email notifier for an email application 130, where new responses 112 can provide IM messages notifying a user 105 that new email messages have been received.

A format and substance of application requests 110 can vary from application 130 to application 130. For example, many conventional applications provide an application program interface 134, which is capable of receiving commands, which are processed by application processor 132, to provide responses 112. In one embodiment, an application request processor 124 of IM application 120 can convert text input to interface 128 directed towards an application 130 into a form the application 130 is able to understand. The request processor 124 can also convert output from application 130 into a user 105 readable message, which is presented in interface 128. In a different embodiment, a target application 130 can be enhanced for IM communications and can include a communication handler 136, which can convert input into a format able to be handled by for processor 132 and that can convert output from processor 132 into a format presentable within interface 128. An intermediary translator (not shown) can also be imposed between an IM application 120 and a target application 130 to convert input/output into suitable forms.

In one contemplated embodiment, IM/application interactions can be simplified by utilizing Representational State Transfer (REST) principles. That is, a set of primitive commands, such as Get, Put, Post, and Delete can be used to statelessly communicate with a exposed functions of one or more target applications 130. The exposed functions/applications can appear as entities in the contact window 126 and can be optionally URL addressable, which would facilitate interactions over network spaces.

The invention is not limited to a particular communication exchange methodology, however, and non-REST interaction approaches are to be considered within scope of the invention.

In various implementations, the IM application 120 and the target application 130 can be remotely located from each other, as shown in scenario 190 or can be local to one another, as shown in scenario 192. In either scenario 190, 192 interactions with a target application 130 can be conducted using IM interface 128.

In scenario 190 an IM server 160 can facilitate interactions and can optionally implement application specific functions. For example, the IM application 120 in scenario 190 can be a standard client application, where application specific enhancements are added by software included in the IM server 160. This software can permit one or more applications 170 to appear as text-exchange communicators and to interact accordingly. Server 160 based implementations can be especially beneficial to facilitate application related interactions when the requesting device 140 is a resource constrained device, such as a mobile phone. That is, server 160 can permit application specific requests 110 and responses 112 using an IM interface 120 of client 140 in situations where device 140 would not typically be able to interact with a target application 130. For instance, device 140 could lack computing resources to locally execute application 130 and/or can include an operating system incompatible with application 130. In scenario 190, the IM application 130 can be a Web based application executing within a browser or a Rich Internet Interface (RII). Additionally, application related IM enhancements need not be directly implemented by server 160, but can be implemented within a device interacting with server 160, such as being implemented as a Web service or within a middleware component accessible by server 160.

In scenario 192, IM based application interactions can be a local enhancement, which can be implemented in an IM server 160 transparent fashion. For example, an IM client residing on computing device 180 can identify and intercept application requests 110, which are not conveyed to an IM server 160 as are standard messages. Once intercepted, the requests 110 can be handled by an application request processor 124, which formats and conveys the requests to locally executing applications 130. The application 130 produced responses 112 can be displayed within the IM interface 128 of application 120. When user 105 is communicating with one or more remote users using application 120 in scenario 192, the application 130 specific messages can be private messages hidden from these remote users by default. Options can be provided within the application 120 so that the user 105 can selectively permit remote communicators to see responses 112 provided by the local target application(s) 130.

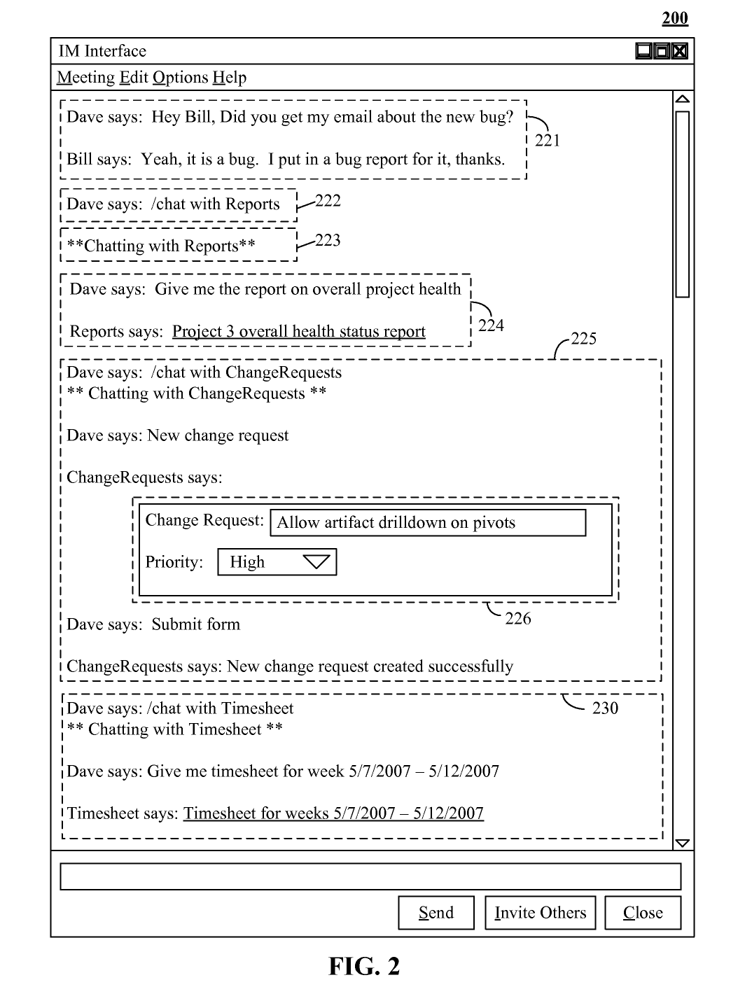

FIG. 2 shows a sample graphical user interface (GUI) 200 for interacting with applications via an IM messages in accordance with an embodiment of the inventive arrangements disclosed herein. GUI 200 can be an interface provided in the context of system 100. In GUI 200, a user can converse with another IM user in addition to sending/receiving messages to/from applications. Interface items 221-226 show an IM interaction involving two users and an application.

In section 211 of the interaction, two users, Dave and Bill, can exchange messages in real-time. In section 222, Dave can type a message directed towards an application, specifically to initiate a “side communication” with a reports application. This side communication can be hidden from Bill or visible to him depending upon configurable interface settings. A notification message of the side communication is shown by a message in section 223.

Dave can submit a request to a “reports” application function and receive a response, which is shown in section 224. The response is a report, which is provided as a hyperlink. Clicking on this link can open a new window in which the report is presented. The new windows can be an instance of the application which generated the response or can be a viewer for the type of file represented by the hyperlinked report. For example, when the report is in an XML based format, the window can be a browser window. In another embodiment, various file type viewers can be incorporated in interface 200, which can be enabled to directly show the reports.

After receiving the report, a change request can be issued via the browser to an application object called tasks. When an appropriate trigger is typed, a change request form linked to the task application can be provided for user selection, as shown in section 226. In one embodiment, a form of section 226 can be an extensible markup language (XML) complaint form, such as XForms. As shown, the form can include a task name field and a task priority entry for quickly adding change requests. In one embodiment, the form can be generated by based on application specific profiles for tasks/tools. In another embodiment, the form can be generated by the responding application. In one configuration, the form can be a file transfer form for an electronic document based upon Web-based distributed authoring and versioning (WebDAV) technologies. The form can be arbitrarily complex as necessary for interacting with the target application. Regardless of how section 226 establishes the form, after making desired selections within it, a command to submit the form can be issued, and submission feedback provided.

After chatting with ChangeRequests, Dave can initiate a chat with Timesheets, as shown by section 230. That is, Dave can request timesheets for a period of time, which is returned by Timesheet as a hyperlink.

As shown herein, GUI 220 is for illustrative purposes only and should not be construed to limit the invention in any regard. The interaction is provided to show that communication can be conducted with a remote user and an application within a single session and within a single IM interface. The interactive arrangements shown in the interface are for exemplary purposes only and are used to illustrate a general IM interface.

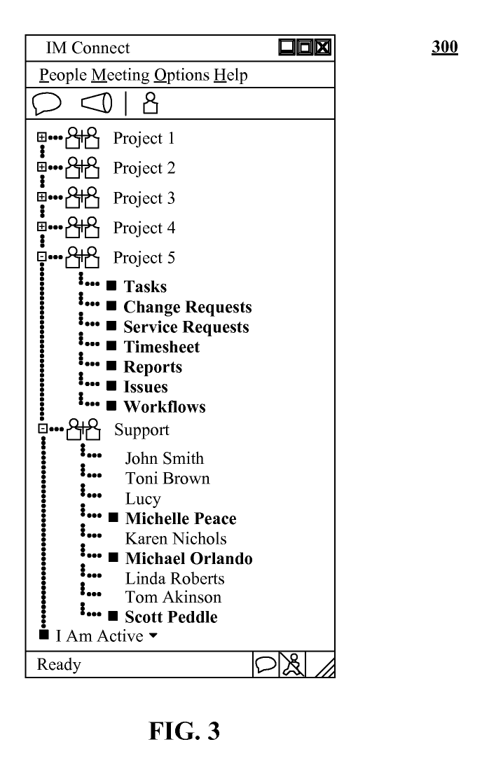

FIG. 3 shows a sample GUI 300 of an IM contact list of an IM application able to interact with applications in accordance with an embodiment of the inventive arrangements disclosed herein. GUI 300 can be a contact list presented concurrently with the IM application shown in GUI 200.

As shown, GUI can include a number of individuals, with whom a user is able to exchange IM communications. An indicator can exist to show whether each individual is currently available or not. For example, Bill, Michael Orlando, and Scott Peddle can be available, as indicated by an availability icon and/or a characteristic font characteristic. Other individuals listed under Support in GUI 300 can be currently unavailable.

GUI 300 also shows a number of application functions, with which a user can interact using IM messages. As shown, these application functions include Tasks, Change Requests, Service Requests, Timesheet, Reports, Issues, and Workflows. Sample interactions with Reports, ChangeRequests, and Timesheet were shown in GUI 200. Other application components, functions, and/or object than those listed can be utilized.

In one embodiment, a user is provided with an ability to chat with a set of objects in a particular domain, such as a project management domain. Different project domains, such as Project 1, Project 2, Project 3, Project 4, and Project 5 can be specified in an IM interface, such as GUI 300. Specific users/application objects belonging to a particular project can be customized by a user. IM messages can be directed to a specific project, which is thereafter sent to every appropriate entity in that project. Filters, parameters, and/or rules can be established to specify which entities under a project are to receive specific message types. Additionally, a set of programmatic actions can be established for different types of IM messages, so that a single IM message can cause a configurable set of actions. All of these contemplated capabilities permit the enhanced IM interface can be utilized as an intelligent project management assistant in one embodiment of the invention.

For example, an IM message of “get project status” can be sent to Project 5. Each human under Project 5 can be sent a status request form, which that human agent is to complete. In addition, each application object under Project 5 (e.g., Tasks, Change Requests, Service Requests, Timesheet, Reports, Issues, and Workflows) can receive the get project status message, which causes each to perform suitable programmatic actions that together result in a set of collected metrics about the project schedule, current issues, risks, etc.

In another embodiment, specific ones of the application object can be associated with a document repository. Sending an IM to such an application object along with a document can cause that document to be placed in the associated repository. Any of a variety of structures can be established for the application objects in GUI 300, which permits a structured contact list to effectively operate as a file-management tool. Files can, for example, be included within IM communications and directed towards a specific Timesheet of Project 5, which updates that timesheet.

The IM interface shown in GUI 200 and 300 can be sufficiently robust to handle information updates of any Web 2.0 repository of electronic files. For example, a structured category of an IM GUI can be established for a WIKI, where sub-elements of the WIKI (e.g., IM application objects) represent updateable WIKI pages. Similarly, BLOGS and other updateable content sources can be updated through IM messages using the techniques described herein.

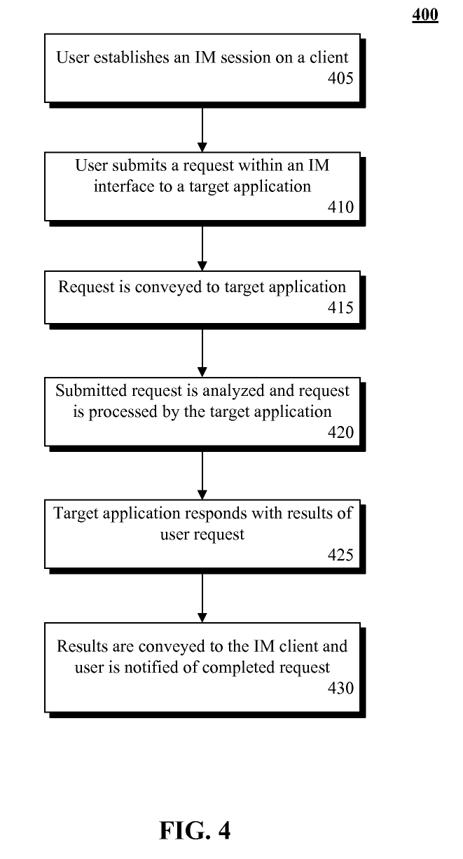

FIG. 4 is a schematic diagram illustrating a method 400 for interacting with applications via an IM client to perform application specific tasks in accordance with an embodiment of the inventive arrangements disclosed herein. Method 400 can be performed in the context of system 100. In method 400, a user can chat with an application object or tool (e.g. report generation feature) to perform application specific activities in lieu of interacting directly with the application graphical user interface (GUI).

In step 405 a user establishes an IM session on an IM client to accomplish one or more objectives. In step 410, the user submits a request within the IM graphical user interface to a target application. In step 415, the request is conveyed to the target application. In step 420, once received, the submitted request is analyzed and the request is processed by the target application. Based on the complexity of the task, target application can optionally notify the user that the current task is being processed. In step 425, the target application responds with the results of the user request. In step 430, the results are conveyed back to the user's IM client and the user is notified of completed request. Notification can be visually and/or aurally presented to the user based on configuration settings and capabilities of the IM client.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for interacting with applications from within an instant messaging interface comprising:
establishing an application entity as a communicator of an instant messaging session, wherein said application entity is at least one of an application, an application function, and an application object, wherein said application and said application function are implemented external to software of an instant messaging client and software of an instant messaging server; and
permitting interactions between a user and the application entity during the instant messaging session, wherein said application entity performs programmatic actions based upon semantic information exchanged during the permitted interactions.

2. The method of claim 1, further comprising:
within an instant messaging interface that is a graphical user interface showing the application entity as a communicator participating in the instant messaging session.

3. The method of claim 1, further comprising:
an instant messaging user interface receiving a user entered message directed towards the application entity;
conveying a request based upon content of the message through an application program interface (API) associated with the application entity; and
the application entity performing a programmatic action based upon the request.

4. The method of claim 3, further comprising:
generating a response as a result of the programmatic action;
conveying the response through the application program interface; and
presenting the response within the an instant messaging user interface.

5. The method of claim 3, further comprising:
an instant messaging user interface receiving user input directed towards another user participating in the instant messaging session; and
conveying the user input to an instant messaging interface of the another user, where the user input is presented to the another user in real-time.

6. The method of claim 3, further comprising:
conveying the user entered message from a client upon which the instant messaging user interface is presented to an instant messaging server that manages the instant messaging session; and
the instant messaging server conveying the user entered message to an application server upon which the application entity executes, wherein said application server is remotely located from the client.

7. The method of claim 3, further comprising:
a software program executing locally upon a client upon which the instant messaging interface is presented detecting the user entered message;
the software program determining that the user entered message is directed towards the application entity, which resides upon the client; and
the software program preventing the user entered message from being conveyed to an instant messaging server that manages the instant messaging session, wherein said software program is digitally encoded within a machine readable medium.

8. The method of claim 1, wherein the application associated with the application entity is one of a word processing application, a spreadsheet application, a database application, an email application, a calendaring application, and a contact management application.

9. The method of claim 1, wherein said steps of claim 1 are performed by at least one machine in accordance with at least one computer program stored in a computer readable media, said computer programming having a plurality of code sections that are executable by the at least one machine.

10. An instant messaging software program comprising:
a set of programmatic instructions digitally encoded in a machine readable medium configured to be executed by at least one computing device, said set of programmatic instructions being configured to permit at least one software application to participate in an instant messaging communication as if the software application were a human participant of a real-time instant messaging session.

11. The program of claim 10, wherein said real-time instant messaging session comprises a plurality of human participants.

12. The program of claim 10, wherein the at least one software program comprises a plurality of software programs, each having an application program interface through which instant messaging communications are conveyed.

13. The program of claim 10, wherein said instant messaging software program is at least one of an instant messaging program, a chat program, and a text messaging program.

14. The program of claim 10, wherein at least one of the application and a function performed by the application are included in a contact list for the instant messaging software program.

15. The software program of claim 10, wherein said instant messaging software program is a client-side program implemented within an instant messaging client in a manner transparent to an instant messaging server that manages the instant messaging communication.

16. The software program of claim 10, wherein said instant messaging software is a server side program implemented within an instant messaging server that manages the instant messaging communication.

17. The software program of claim 10, wherein said instant messaging software is implemented in middleware and which provides an ability to communicate with applications via an instant messaging interface as a Web service.

18. The software program of claim 10, wherein the software application is one of a word processing application, a spreadsheet application, a database application, an email application, a calendaring application, and a contact management application.

19. An instant messaging graphical user interface comprising:
a session input region configured to receive user entered text, which is submitted to other users participating in a real-time instant messaging communication session, wherein said session input region is configured to receive input which is conveyed to at least one application through an application program interface, wherein the application performs programmatic actions based upon semantic content contained within the received input; and
a session output region configured to present text conveyed among user during the real-time instant messaging communication session, wherein the session output region is configured to present output generated by the at least one application that has been conveyed through the application program interface, wherein the at least one application is treated by the instant messaging graphical user interface as if the at least one application was a human participant of the real-time instant messaging session.

20. The instant messaging graphical user interface of claim 19, wherein said at least one application comprises a plurality of applications, wherein each of said plurality of applications is at least one of a word processing application, a spreadsheet application, a database application, an email application, a calendaring application, and a contact management application.
